(19) United States
(12) Patent Application Publication
(10) Pub. No.: US 2017/0074352 A1
(43) Pub. Date: Mar. 16, 2017

(54) ROCKER JOINT FOR A PLATE LINK CHAIN

(71) Applicant: Schaeffler Technologies AG & Co. KG, Herzogenaurach (DE)

(72) Inventors: Stephan PENNER, Bühl (DE); Jürgen OCHS, Bühl (DE); Konstantin BRAUN, Rastatt (DE)

(73) Assignee: Schaeffler Technologies AG & Co. KG, Herzogenaurach (DE)

(21) Appl. No.: 15/308,407

(22) PCT Filed: Apr. 15, 2015
(86) PCT No.: PCT/DE2015/200258

§ 371 Date: Nov. 2, 2016

(30) Foreign Application Priority Data
May 7, 2014 (DE) 10 2014 208 582.9

(51) Int. Cl. F16G 13/06

(52) U.S. Cl. CPC F16G 13/06

(57) ABSTRACT

A rocker joint for a plate link chain. The rocker joint is defined by pairs of contacting rocker pressure pieces that pass through openings formed in chain link plates. Each of the rocker pressure pieces has a rocker pressure piece height, and each includes a rocker pressure piece rocking radius that is in contact with the rocking radius of an adjacent rocker pressure piece. The ratio between the rocking radius and the rocker pressure piece height of the rocker pressure pieces is selected to be small so that a contact point of the contacting rocker pressure pieces moves less far than conventional rocker pressure piece movements during travel of the plate link chain around and between pairs of spaced conical disks.

### CROSS-REFERENCE TO RELATED APPLICATION

This application is the U.S. national phase patent application under 35 U.S.C. §371 of International Patent Application Serial No. PCT/DE2015/200258, having an international filing date of 15 Apr. 2015, and designating the United States, which claims priority based upon German Patent Application No. DE 10 2014 208 582.9, filed on 7 May 2014, the entire contents of each of which applications are hereby incorporated by reference herein to the same extent as if fully rewritten.

### BACKGROUND OF THE INVENTION

### Field of the Invention

The present invention relates to a rocker joint for a plate link chain having a pair of rocker pressure pieces which have a rocker pressure piece height and a rocking radius. The present invention also relates to a plate link chain having such a rocker joint. In addition, the invention relates to a system for designing such a plate link chain. a plate link chain is known, the chain having a plurality of link plates connected to one another with articulated connection by means of rocker members. To achieve a more uniform pressure load on the lower and upper link plate straps of the link plates, the ratio of the distance from an end of an upper region to the center of mass and the distance from an end of a lower region to the center of mass falls in a range from about 1.1 to about 2. A similar plate link chain having rocker joints is known from U.S. Pat. No. 5,651,746.

An object of the present invention is to prolong the life of a plate link chain having rocker joints that include a pair of rocker pressure pieces that have a rocker pressure piece height and a rocking radius.

### SUMMARY OF THE INVENTION

The above-noted object is achieved by a rocker joint for a plate link chain having a pair of rocker pressure pieces that have a rocker pressure piece height and a rocking radius, wherein the ratio between the rocking radius and the rocker pressure piece height is so small that a contact point of the rocker pressure pieces migrates a lesser distance during operation of the plate link chain.

When the plate link chain is in the installed state, the rolling radii of the rocker pressure pieces rest against one another, viewed in cross section through the rocker pressure pieces. The points at which the rolling radii of the rocker pressure pieces touch one another are also known as contact points or force application points. During operation of the plate link chain, the rocker pressure pieces of a rocker pressure piece pair are angled relative to one another in the area of conical disk pairs. In the chain strands between the conical disk pairs, the rocker pressure pieces are not angled but straightened. The interval or distance between the contact point in the angled position and the contact point in the straightened position is referred to as migration or deflection of the force application point.

The load on a link plate of a plate link chain depends to a great degree on the rocking radius of the rocker pressure pieces. The smaller the rocking radius chosen, the smaller the deflection of the force application point. Viewed over a circulation path of the chain, that ensures on the one hand better distribution of the dynamic loads between an upper and a lower link plate strap of the link plates. On the other hand, relative movement between the rocker pressure piece and the link plate is reduced. That relative movement between the rocker pressure piece and the link plate is also referred to as microslip. Choosing the ratio between the rocking radius and the rocker pressure piece height in accordance with the present invention achieves the result in a simple way that the contact point of the rocker pressure pieces migrates less far during operation of the plate link chain than with conventional rocker joints.

A preferred exemplary embodiment of the rocker joint is characterized in that the ratio between the rocking radius and the rocker pressure piece height is less than or equal to 1.35. In trials carried out in conjunction with the present invention, it was found that the load on the link plates during operation of a plate link chain can be reduced noticeably with the rocker joint configuration according to the present invention.

Another preferred exemplary embodiment of the rocker joint is characterized in that the ratio between the rocking radius and the rocker pressure piece height is greater than or equal to 0.95. In trials carried out in conjunction with the present invention, it was also found that the load on the link plates during operation of a plate link chain having the rocker joint according to the present invention is more likely to increase again if the ratio between the rocking radius and the rocker pressure piece height becomes less than 0.95.

Another preferred exemplary embodiment of the rocker joint is characterized in that the ratio between the rocking radius and the rocker pressure piece height is less than or equal to 0.99. The range between 0.95 and 0.99 for the ratio between the rocking radius and the rocker pressure piece height has proven to be especially beneficial in the trials conducted in conjunction with the present invention.

The present invention also relates to a plate link chain having rocker joints as described above. Preferably, two rocker joints as described above are assigned to each link plate of the plate link chain.

A preferred embodiment of the plate link chain is characterized in that all rocker joints of the plate link chain have essentially the same rocker pressure piece height. That simplifies the fabrication and assembly of the plate link chain.

A preferred embodiment of the plate link chain is characterized in that all rocker joints of the plate link chain have essentially the same rocking radius. That achieved the best results in the trials conducted in conjunction with the present invention.

In a method for designing a plate link chain as described above, the object stated above is achieved alternatively or additionally by the ratio between the rocking radius and the rocker pressure piece height being chosen less than or equal to 1.35.

A preferred exemplary embodiment of the method is characterized in that the ratio between the rocking radius and the rocker pressure piece height is less than or equal to 0.99 and/or greater than or equal to 0.95. That range has proven to be advantageous in the trials conducted in conjunction with the present invention.

In addition, the present invention relates to a rocker pressure piece for a rocker joint described above, in particular for a plate link chain described above. The rocker pressure piece is marketable separately.

The present invention also relates to a CVT transmission having a plate link chain as described above. In the CVT transmission, the plate link chain serves to connect two sets of conical disks or two conical disk pairs with one another as a drive. The letters CVT stand for continuously variable transmission, and mean that the CVT transmission is variable by stepless adjustments.

### BRIEF DESCRIPTION OF THE DRAWINGS

Additional advantages, features, and details of the present invention can be seen from the following description, in which various exemplary embodiments are described in detail with reference to the drawing. The drawing figures show the following:

FIG. 1 shows a simplified side view of a link plate of a plate link chain having two rocker pressure piece pairs that constitute rocker joints,

FIG. 2 shows an enlarged end view of one of the rocker joints having a larger rocking radius, and

FIG. 3 shows the same end view as as is shown in FIG. 2 with a smaller rocking radius.

### DESCRIPTION OF THE PREFERRED EMBODIMENTS

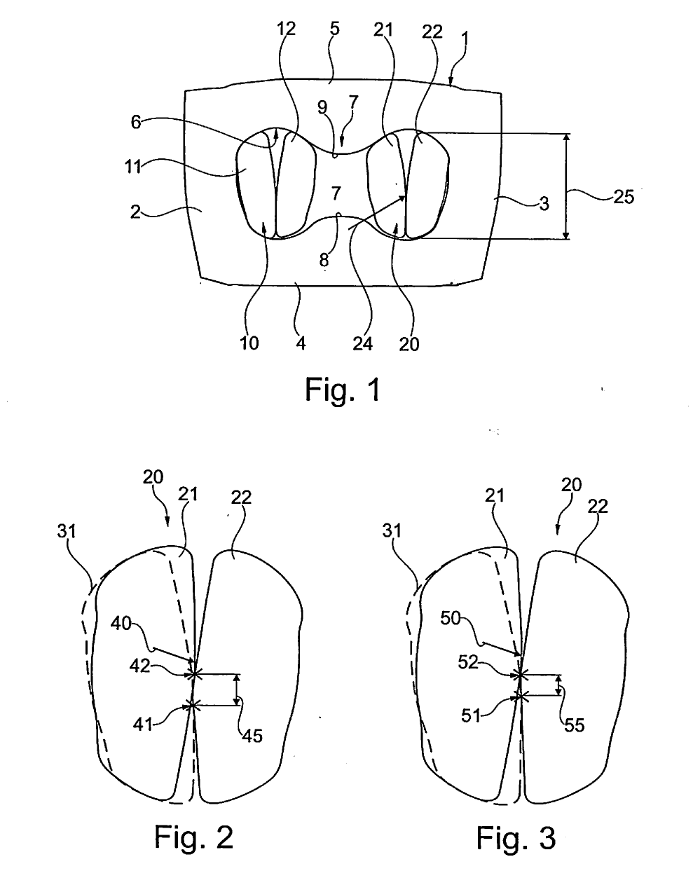

The link plate 1 shown in FIG. 1 includes a left link plate side strap 2 and a right link plate side strap 3. The link plate side straps 2 and 3 are joined together in a single piece at the bottom by a lower link plate strap 4. At the top, the two link plate side straps 2 and 3 are joined together in a single piece by an upper link plate strap 5.

The link plate 1 includes a common opening 6 for two rocker pressure piece pairs 10 and 20. The rocker pressure piece pair 10 includes two rocker pressure pieces 11 and 12. The rocker pressure piece pair 20 includes two rocker pressure pieces 21 and 22.

The common opening 6 in the link plate 1 is provided in a middle region 7 with curves 8 and 9. The curve 8 has essentially the shape of a circular arc is formed convexly on the lower link plate strap 4. The curve 9 likewise has the shape of a circular arc that is formed convexly on the upper link plate strap 5.

Rocker pressure piece pairs 10 and 20 constitute rocker joints. A plate link chain having link plates 1 and rocker pressure piece pairs 10, 20 is therefore also referred to as a rocker joint chain. The plate link chain or rocker joint chain is employed, for example, in chain-driven conical pulley transmissions. Chain-driven conical pulley transmissions, which are also referred to as CVT transmissions, include two conical disk pairs, which are encircled by the plate link chain to transmit torque.

Upon entering into a conical disk pair, the plate link chain goes from an extended or straight attitude or position to an angled attitude or position. Analogously, when exiting from the conical disk pair, the plate link chain goes from the angled attitude into the extended attitude.

In FIG. 1 a rolling radius of the rocker pressure piece 21 is indicated by an arrow 24. The rocker pressure piece 22 is designed symmetrical to the rocker pressure piece 21, and has the same rolling radius. A double arrow 25 in FIG. 1 indicates a rocker pressure piece height. The rocker pressure pieces 11,12 and 21, 22 all have the same rocker pressure piece height.

The smaller the rocking radius 24 chosen, the smaller is a deflection of a force application point between the rocker pressure pieces 11, 12 and 21, 22 of the rocker pressure piece pairs 10 and 20 during movement of the plate link chain as it passes around and between a pair of conical disks. Viewed over a circulation of the chain, that achieves on the one hand better distribution of the dynamic loads between the upper link plate strap 5 and the lower link plate strap 4 of the link plate 1.

On the other hand, a relative movement between the rocker pressure pieces 11, 12 and 21, 22 and the link plate 1, also referred to as microslip, is reduced. In trials and investigations conducted in conjunction with the present invention, it was found that the ratio between the rocking radius 24 and the rocker pressure piece height 25 should be small.

It was also found in the trials and investigations conducted in conjunction with the present invention that the ratio between the rocking radius 24 and the rocker pressure piece height 25 should be a maximum of 1.35 to effectively reduce the load on the plate links. In tests on prototypes, excellent results were achieved with ratios of about 0.95 to 0.99 between the rocking radius 24 and the rocker pressure piece height 25.

FIGS. 2 and 3 illustrate the contact point migration or deflection with different rocking radii. The contours of the rocker pressure pieces 21 and 22 are represented in FIGS. 2 and 3 by solid lines. The solid lines show the rocker pressure piece 21 in its angled position. A dashed line 31 is used in FIGS. 2 and 3 to represent the rocker pressure piece 21 in its angled position.

A relatively large rocking radius of the rocker pressure piece 21 is to represented in FIG. 2 by an arrow 40. A symbol X indicated by reference numeral 41 designates a contact point between the rocker pressure piece 22 and the rocker pressure piece 31 when a chain is in its extended or linear position. A symbol X indicated by reference numeral 42 designates a contact point between the rocker pressure piece 22 and the rocker pressure piece 21 when the chain is in its angled, curvilinear position.

A double arrow 45 illustrates a distance or deflection between the contact points 41 and 42. The distance 45 represents the migration of the contact point or force application point when the rocking radius 40 is relatively large.

In FIG. 3 a relatively smaller rocking radius than that of FIG. 1 is represented by an arrow 50. A symbol X indicated by reference numeral 51 designates a contact point between the rocker pressure piece 22 and the rocker pressure piece 31 when a chain is in its extended or linear position. A symbol X indicated by reference numeral 52 designates a contact point between the rocker pressure piece 22 and the rocker pressure piece 21 when the chain is in an angled position. A double arrow 55 illustrates a distance or deflection between the points 51 and 52. The distance 55 is significantly smaller than the distance 45 shown in FIG. 2. The smaller rocking radius 50 thus enables the contact point migration to be reduced significantly.

1: A rocker joint for a plate link chain, said rocker joint comprising:
a pair of rocker pressure pieces in which each rocker pressure piece has a rocker pressure piece height and a rocker surface defined by a rocking radius, the wherein a ratio between the rocking radius and the rocker pressure piece height of the rocker pressure pieces has a value such that a contact point of the rocker surfaces of contacting rocker pressure pieces moves less far than contact points of conventional rocker pressure piece movements during movement of the plate link chain as it passes around a pair of conical disks.

2: A rocker joint according to claim 1, wherein the ratio between the rocking radius and the rocker pressure piece height is less than or equal to 1.35.

3: A rocker joint according to claim 1, wherein the ratio between the rocking radius and the rocker pressure piece height is greater than or equal to 0.95.

4: A rocker joint according to claim 1, wherein the ratio between the rocking radius and the rocker pressure piece height is less than or equal to 0.99.

5: A plate-link chain having rocker joints according to claim 1.

6: A plate link chain according to claim 5, wherein each of the rocker pressure pieces forming respective rocker joints of the plate link chain have substantially the same rocker pressure piece height.

7: A plate link chain according to claim 5, wherein each of the rocker pressure pieces forming rocker joints of the plate link chain have substantially the same rocking radius.

8: A method for forming a plate link chain, said method comprising the steps of:
providing a plurality of link plates having openings for receiving pairs of contacting rocker pressure pieces, each rocker pressure piece having a rocker pressure piece height and a rocker surface defining a rocking radius and at which contact surface pairs of rocker pressure pieces are in contact with each other; and
establishing a ratio between the rocking radius and the rocker pressure piece height of the rocker pressure members is selected to be less than or equal to 1.35.

9: A method according to claim 8, including the step of selecting the ratio between the rocking radius and the rocker pressure piece height to be less than or equal to 0.99 and/or and greater than or equal to 0.95.

10: A rocker pressure piece for a rocker joint according to claim 1 for a plate link chain according to claim 5.
